(19) United States
(12) Patent Application Publication
(10) Pub. No.: US 2026/0018889 A1
(43) Pub. Date: Jan. 15, 2026

(54) INTELLIGENT RELAY-BASED LOAD MANAGEMENT SYSTEM WITH MACHINE LEARNING OPTIMIZATION AND MOBILE APPLICATION CONTROL FOR BATTERY ENERGY STORAGE SYSTEMS

(71) Applicant: Neubau Energy Inc, San Rafael, CA (US)

(72) Inventor: Thomas Enzendorfer, San Anselmo, CA (US)

(21) Appl. No.: 19/338,277

(22) Filed: Sep. 24, 2025

Related U.S. Application Data
(63) Continuation-in-part of application No. 18/679,319, filed on May 30, 2024.
(60) Provisional application No. 63/699,004, filed on Sep. 25, 2024.
(60) Provisional application No. 63/751,551, filed on Jan. 30, 2025.

(51) Int. Cl. H02J 3/00; H02J 3/14; H02J 3/32; H02J 13/00

(52) U.S. Cl. CPC H02J 3/003; H02J 3/0012; H02J 3/144; H02J 3/32; H02J 13/00001; H02J 13/00024; H02J 13/0004; H02J 2203/10; H02J 2203/20; H02J 2310/60

(57) ABSTRACT

A load management system integrates comparator-based neutral sensing, machine learning prediction, and relay control into a single integrated “AC” board requiring no additional wiring. A highspeed comparator circuit detects grid failures in sub millisecond timeframes, providing clean data to a temporal convolutional network that predicts load requirements 24 hours in advance with integration of external data sources such as weather and time of use pricing. The system automatically manages 120V and 240V circuits during grid transitions, learning from user override patterns to continuously improve performance. A mobile application provides real-time monitoring and control. The integration of low-latency sensing with predictive machine learning enables performance improvements exceeding 40% in battery runtime compared to conventional systems, while reducing installation time and cost.

### CROSS-REFERENCE TO RELATED APPLICATIONS

This Non-Provisional patent application claims the benefit of and priority to U.S. Provisional Patent Application No. 63/699,004 filed on Sep. 25, 2024, titled “DYNAMIC RELAY-BASED INTELLIGENT ELECTRICAL LOAD MANAGEMENT AND ENERGY CONSERVATION SYSTEM FOR OFF-GRID POWER SYSTEMS”, by inventor Thomas Enzendorfer, the contents of which are expressly incorporated herein by this reference as though set forth in their entirety. This Non-Provisional patent application also claims the benefit of and priority to U.S. Provisional Patent Application No. 63/751,551 filed on Jan. 30, 2025, titled “RAPID SHUTDOWN SYSTEM FOR PHOTOVOLTAIC MODULES USING A SINGLE-FREQUENCY PILOT SIGNAL GENERATED BY A STANDALONE AC BOARD WITHIN A BATTERY ENERGY STORAGE SYSTEM”, by inventor Thomas Enzendorfer, the contents of which are expressly incorporated herein by this reference as though set forth in their entirety. This Non-Provisional patent application is a Continuation-in-Part of U.S. Non-Provisional patent application Ser. No. 18/679,319 filed on May 30, 2024, titled “Residential Battery System”, the contents of which are expressly incorporated herein by this reference as though set forth in their entirety and to which the benefit of and priority to is claimed.

### FIELD OF DISCLOSURE

The present disclosure relates to electrical load management systems for battery energy storage systems (BESS) and inverter systems. More particularly, the present disclosure relates to an intelligent relay-based system that employs machine learning algorithms, comparator-based neutral sensing, and mobile application control in order to dynamically manage 120V and 240V loads during grid-tied and off-grid operations without requiring additional physical wiring infrastructure.

### BACKGROUND

Battery energy storage systems and backup power systems have become increasingly important for residential and commercial applications. However, managing electrical loads during transitions between grid-tied and off-grid operation presents significant technical and economic challenges. Conventional load management systems typically require extensive infrastructure modifications to segregate critical circuits from non-essential circuits. These modifications often include installing separate electrical panels, running additional wiring through walls and conduits, and adding dedicated circuit breakers for critical loads. Such installations can cost homeowners thousands of dollars in materials and labor, require multiple days of electrical work, and often necessitate opening walls and ceilings to run new wiring.

Existing relay-based switching systems in the market operate using static, predetermined rules for load shedding. These systems disconnect loads based on simple threshold values or fixed priorities that cannot adapt to changing household usage patterns or user preferences. Once configured during installation, these priorities remain unchanged unless manually reprogrammed by a technician.

Current sensing technologies for detecting grid failures and neutral conditions typically rely on heavy isolation transformers. Heavy isolation transformers add significant weight to electrical panels, introduce response delays of 10 milliseconds or more, and can suffer from saturation issues during fault conditions. The slow response time of transformer-based sensing can lead to equipment damage during rapid grid fluctuations.

Load management systems prior to the systems of the present disclosure provide, at best, limited user control once installed. Homeowners cannot adjust load priorities based on immediate needs, cannot override automatic decisions during emergencies, and have no visibility into system operation or battery consumption predictions. This inflexibility forces users to choose between complete automation with no control or manual operation with no computer intelligence assistance.

Furthermore, current systems operate reactively rather than predictively. They respond to conditions as the conditions occur without anticipating future needs or learning from past behavior. This reactive approach leads to inefficient battery utilization, unexpected load disconnections at inconvenient times, and/or an inability to optimize for varying usage patterns throughout different seasons or lifestyle changes.

The integration of renewable energy sources and time-of-use electricity pricing has created additional complexity that current systems do not and cannot address. Systems prior to the systems of the present disclosure do not and are not (i) able to predict solar generation based on weather forecasts, (ii) optimize load scheduling for variable electricity rates, and (iii) learn from historical generation and consumption patterns to improve performance over time.

Thus, there exists a significant need for a load management system that eliminates infrastructure modification requirements, provides intelligent adaptation to usage patterns, enables real-time user control and override capabilities, operates predictively rather than reactively, and integrates seamlessly with modern smart home ecosystems.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to an intelligent relay-based system that employs machine learning algorithms, comparator-based neutral sensing, and a mobile application control in order to dynamically manage 120V and 240V loads during grid-tied and off-grid operations without requiring additional physical wiring infrastructure. One objective is to conserve energy by prioritizing essential 120V loads while allowing for user-controlled reactivation of 240V circuits when needed.

The systems of the present disclosure may address the limitations of prior systems through a novel integration of machine learning algorithms, comparator-based sensing technology, and mobile application control, which may all be consolidated into a single AC board that requires no additional wiring infrastructure. A comparator may be an integrated circuit that compares two voltages and outputs a digital signal indicating which voltage is higher.

The system may employ a unique combination of high-speed comparator circuits providing sub-millisecond neutral sensing, temporal convolutional neural networks analyzing usage patterns to predict future load requirements, and relay switches whose operation is predictively controlled based on learned patterns. This specific integration may produce unexpected synergies: the clean, low-latency data from the comparator may enable the machine learning algorithm to achieve prediction accuracies not possible with traditional sensing methods, while the predictive positioning of relays based on learned patterns eliminates switching delays and extends relay life.

The mobile application interface may provide users with a degree of control while maintaining intelligent automation. Users may override automatic decisions with immediate effect, adjust load priorities dynamically based on current needs, and view predictive analytics showing expected battery life under various scenarios and loads. The system may record, identify, and learn from these user interactions, continuously improving the automatic behavior to better match user preferences.

The elimination of additional wiring may be achieved through the relay configuration and control logic that manages both 120V and 240V circuits from a single integrated board. This approach reduces installation time from days to approximately 15 minutes, eliminates the need for wall modifications, and saves thousands of dollars in installation costs.

One embodiment of the system of the present disclosure comprises the following features: (1) Relay-Based Load Management—the system uses relays to dynamically separate and switch 120V and 240V circuits without requiring extra physical wiring; (2) Automatic 240V Load Shedding—during off-grid mode, the controller automatically disconnects 240V heavy-load circuits while maintaining 120V circuits for essential loads; (3) User-Controlled 240V Reactivation—users can manually override the system to re-engage 240V circuits as needed, providing flexibility while still prioritizing energy conservation; (4) Neutral Sensing with Comparator—the system incorporates comparator-based neutral sensing, which enhances safety and reliability by detecting neutral faults electronically instead of using heavy isolation transformers; (5) Integrated Auto-Transfer Switching (ATS)—ATS ensures seamless switching between grid-tied and off-grid modes. Relay control enables efficient management of 120V and 240V circuits.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow schematic illustration that shows one embodiment of the overall system architecture showing the integrated alternating current board (“AC Board”).

FIG. 2 is an illustration showing one embodiment of a comparator-based neutral sensing circuit schematic.

FIG. 3 is an illustration of one embodiment of a mobile application with a graphical user interface.

FIG. 4 is a flow diagram of one embodiment of a machine-learning algorithm architecture based on Temporal Convolutional Networks (TCN) with dilated convolutional layers and an output layer producing minute-resolution predictions.

FIG. 5 is a state transition diagram of one embodiment for relay switching between grid-tied and off-grid modes with timing annotations.

FIG. 6 is an illustration that presents comparative performance graphs including battery runtime improvement, prediction-accuracy evolution, and user-override frequency.

FIG. 7 is a data-flow diagram of one embodiment of the system showing sensor inputs, feature extraction, TCN training, prediction generation, and action selection.

FIG. 8 is a block diagram that shows integration of external data sources with the predictive algorithm framework on the machine learning (ML) processor, including weather, time-of-use pricing, and internal sensor data, and the resulting optimized schedules and relay commands.

FIG. 9 is an illustration of an exploded view of one embodiment of the hardware of the system enclosure.

FIG. 10 is an illustration of one embodiment of wiring diagram of the system showing the relays that automatically shut off power to the 240V load/s when in off-grid mode.

FIG. 11 is an illustration of one embodiment of a relay and breaker control schematic showing protection devices and control paths for S1-S3 and associated measurement points.

FIG. 12 is an illustration of one embodiment of an installer setup interface showing commissioning workflows and parameter provisioning.

FIG. 13 is an illustration of an exploded view of one embodiment of an internal hardware of the system.

FIG. 14 is a flow block diagram of one embodiment of a wiring and harness map of the system.

FIG. 15A is a relay switching timing chart showing grid-loss detection, S1/S3 actuation, S2 hold, and soft-close of S1 upon grid return.

FIG. 15B is an inset zoom of FIG. 15A for 0-10 millisecond events.

FIG. 16 is a block diagram of one embodiment of the system showing the experimental validation setup.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, electric charge storage device, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Managing 120V and 240V loads in off-grid systems is traditionally costly and inefficient, often requiring dedicated circuits or risking rapid battery depletion when all loads are treated equally. The conventional method involves pulling additional wiring and installing separate breaker boxes for critical circuits, increasing both cost and installation time. The system of the present disclosure offers a more elegant solution by dynamically shedding only the largest 240V loads through a relay system, allowing homeowners/users to re-engage these circuits via a mobile app when necessary. This may optimize battery usage, ensuring an ideal balance between maintaining critical loads and user flexibility in off-grid scenarios.

The present system may use machine learning integration for load management. The system may have a machine learning engine processor (on site or remote) that continuously processes real-time inputs such as: Battery status; Power consumption; User preferences; Weather and solar forecasts. These data points may allow the system to predict energy demand and optimize load shedding dynamically.

The machine learning model may involve several phases: (1) Data Collection—inputs from sensors, historical data, and external APIs (e.g., solar energy forecasts) are collected; (2) Prediction—the model analyzes real-time and historical data to predict upcoming energy demands and availability; (3) Prioritization—based on predictions, the system assigns load priorities to ensure that critical circuits remain active while non-essential loads are shed; (4) Load Shedding and Reactivation—the system dynamically manages relays to shed or re-engage circuits based on load prioritization; and (5) Feedback Loop—performance data and user interactions are saved, processed, and incorporated into the machine learning model to continuously refine future decisions.

The mobile application may preferably be a software application for mobile devices such as smartphones, tablet computers, laptop computers, and wearables. In other embodiments, the mobile application may be software that is run on any computer, server, or electronic data processing device.

### LIST OF REFERENCE NUMERALS

100 Integrated AC Board, which may be an integrated circuit board specifically for managing alternating current power systems
110 Intelligent Relay Control System
111 S1 (switch 1)
112 S2 (switch 2)
113 S3 (switch 3)
115 Machine Learning Processor
120 Comparator-Based Neutral Sensing Circuit
131 Autotransformer
200 Mobile Application (which may have a graphical user interface)
900 Outer Enclosure Cover
910 Cooling/Fan Unit
920 Battery Modules (for example, as disclosed in in U.S. Published Patent Application No. US2024/0405343)
930 Mounting Backplate

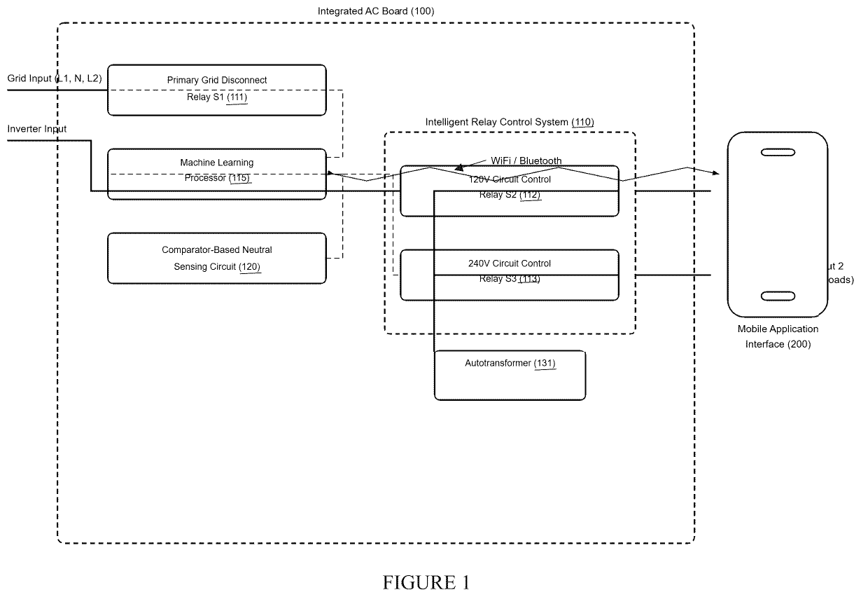

FIG. 1 is a flow schematic illustration that shows one embodiment of the overall system architecture showing the integrated alternating current board (“AC Board”). As shown in FIG. 1, the system may have relay configuration S1 111 (switch one), S2 112 (switch two), S3 113 (switch three), comparator-based neutral sensing circuit 120, machine learning processor 115, and a wireless link to the mobile application 200. As shown in FIG. 1, integrated alternating current (AC) board 100 consolidates sensing, computation, and relay control. AC board 100 may be wireless connected with mobile application 200.

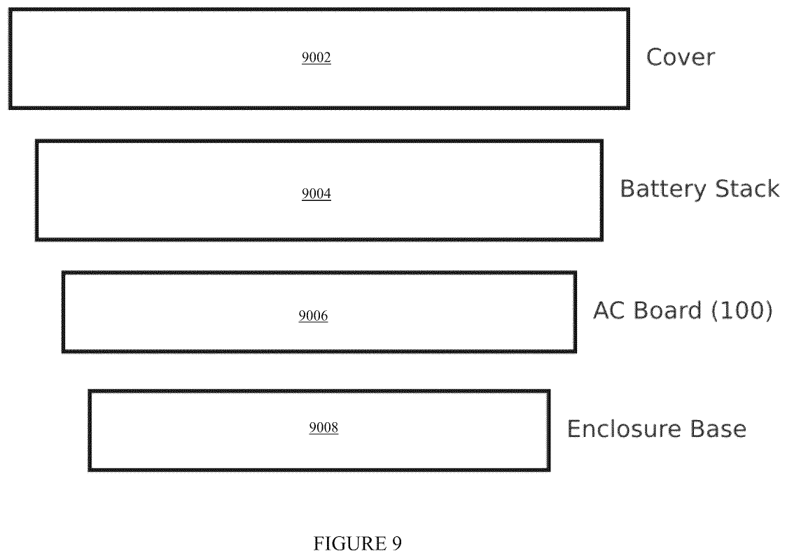

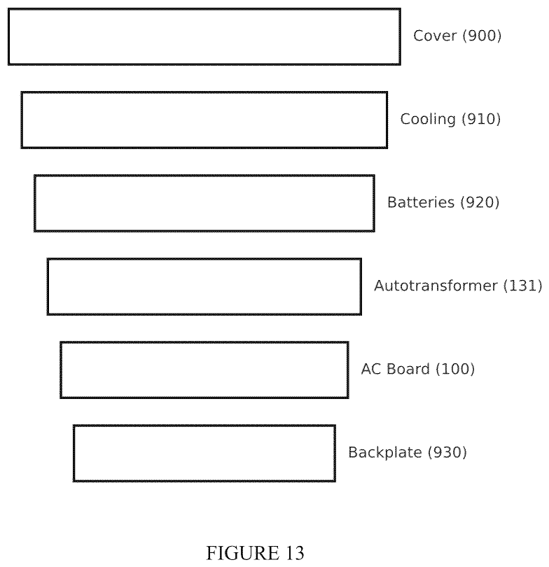

One embodiment of the hardware of a system incorporating integrated AC board 100, including the mechanical stack and serviceability, are shown in FIGS. 9 and 13, which illustrate the enclosure-level exploded perspective and the internal layered arrangement, respectively.

FIG. 1 shows grid power input through line 1 (L1), line 2 (L2), and neutral line (N). L1 and L2 typically represent the two different hot (or live) conductors of a split-phase power supply, while N is the neutral conductor. L1 and L2 are important for 240V loads (machines/equipment/appliances), both L1 and L2 are connected. For 120V loads (machines/equipment/appliances), either L1 or L2 are connected, but not both. L or line is a current-carrying conductor, while N represents the neutral wire, which returns current to the source, and may be a safety ground wire. S1 111 may be the primary grid disconnect relay, which is connected to machine learning processor 115, which is connected to comparator-based neutral sensing circuit 120, which is connected to intelligent relay control system 110.

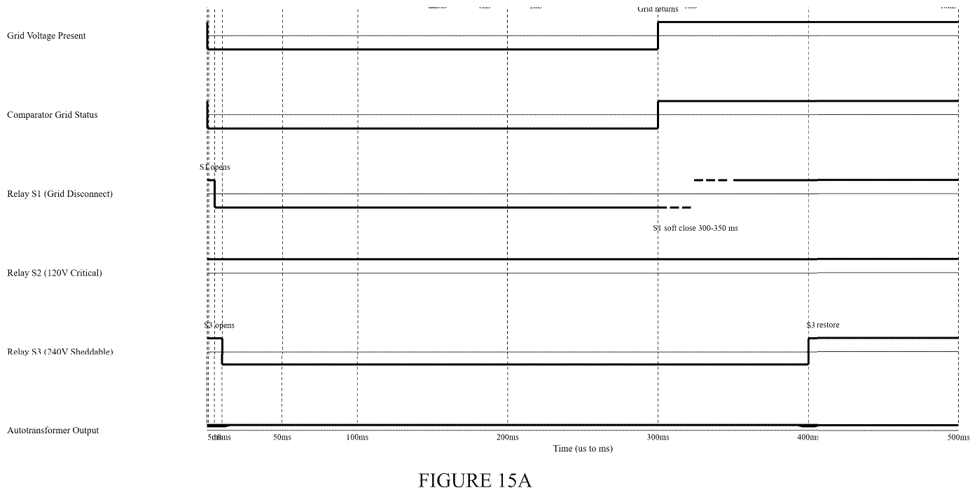

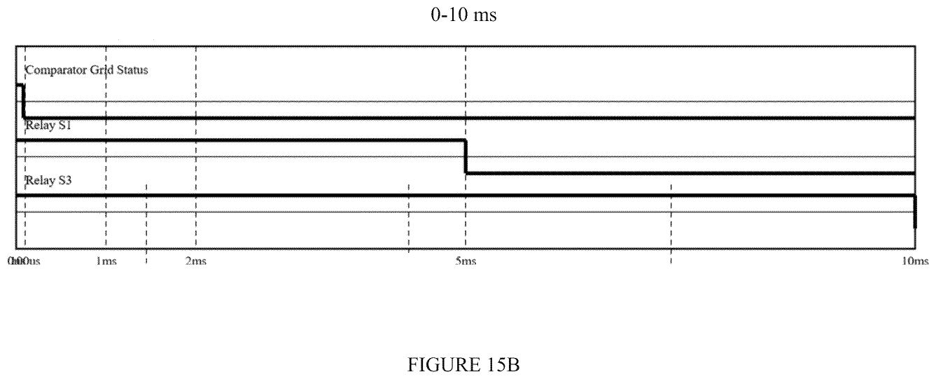

FIG. 1 also shows that inverter input may be connected to intelligent relay control system 110. As shown, intelligent relay control system 110 may be connected to S1 111 (switch one), and may include S2 112 (switch two), and S3 113 (switch three), and the three of which may be driven/controlled by machine learning processor 115. S1 111, provides (i) isolation between the grid input and downstream circuits and (ii) implements soft-switching control. Soft-switching refers to a process or technique to reduce switching losses and electromagnetic interference (EMI) in power systems/converters by ensuring, or attempting to ensure, that power switches turn on and off when either the current or the voltage across them is near zero. This preferably minimizes the power dissipated during the transition periods, allowing for higher operating frequencies and smaller component sizes while improving overall efficiency compared to hard switching. Timing of open/close events relative to grid loss and restoration is depicted in FIG. 15 (5 millisecond (ms) open and 300-350 ms soft-close).

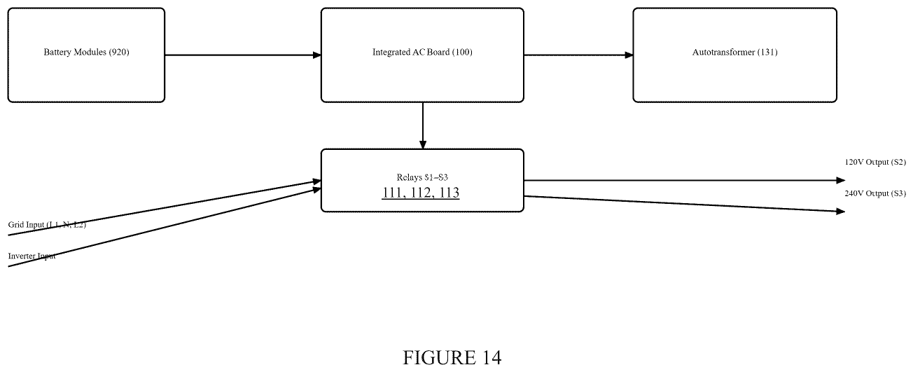

S2 112 may manage the 120V output circuit for critical loads. S3 113 controls the 240V output circuit for sheddable loads. Electrical placement and harnessing relative to the autotransformer 131 are shown in FIG. 14.

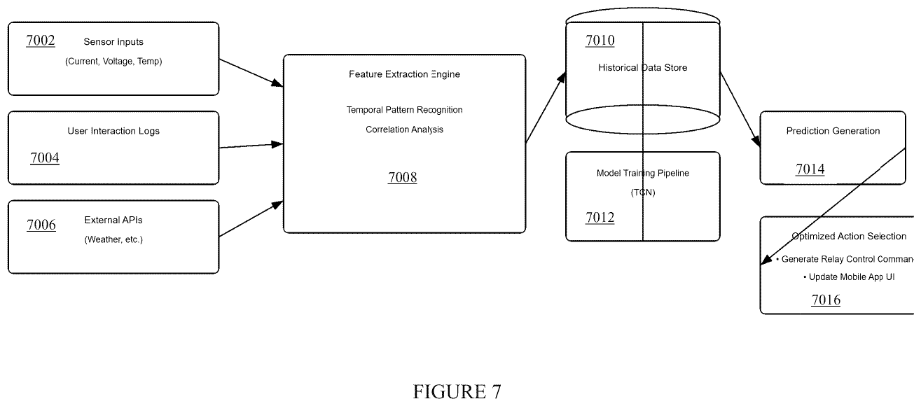

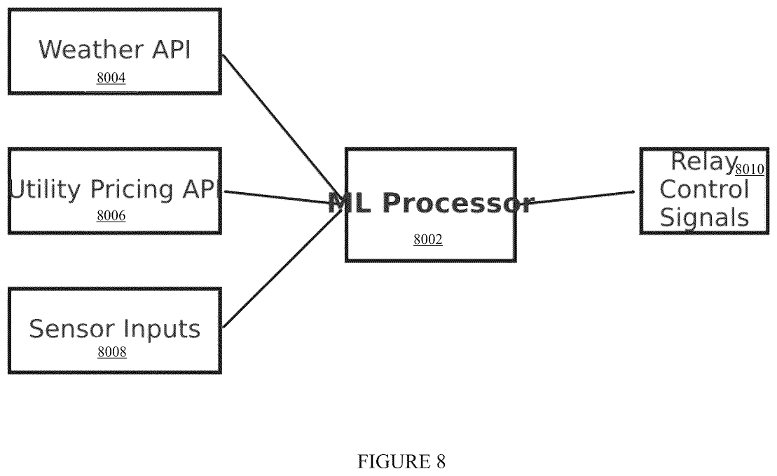

Machine learning processor 115 may, in some embodiments, execute a temporal convolutional network (TCN) trained on minute-resolution histories and contextual features. Input/output context and external-data integration (weather and time-of-use pricing) are illustrated in FIG. 8, and end-to-end data flow is shown in FIG. 7.

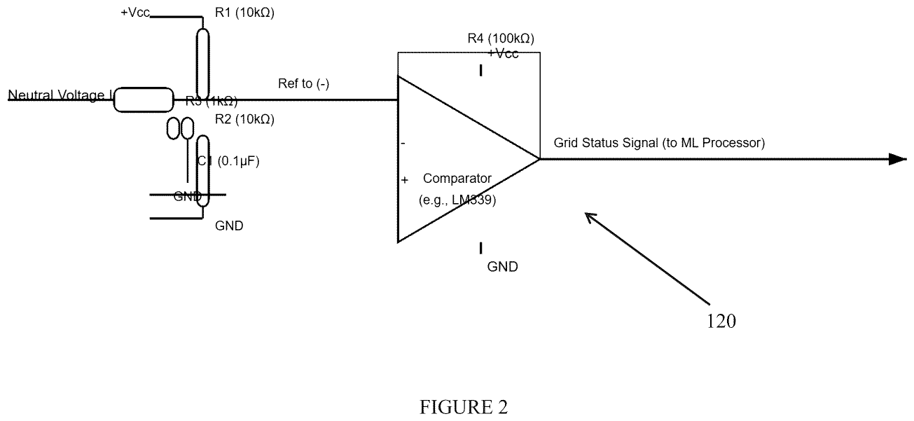

Comparator-based neutral sensing circuit 120, as shown in FIG. 2 may generate a grid status signal in sub-millisecond timeframes. The temporal alignment of comparator events with relay actuation is shown in FIG. 15. A comparator-based neutral sensing circuit, in general, may detect the absence or presence of a neutral wire by comparing the voltage of a sensing component against a reference voltage. A comparator circuit may be made using a dedicated integrated circuit or an operational amplifier, and it may amplify the voltage difference to produce a digital output (high or low) indicating whether the input voltage is above or below the threshold, which may signal the neutral condition.

Autotransformer 131, as shown, is preferably positioned between S2 112 and S3 113, see FIG. 14, for voltage balancing and soft start. The effect of autotransformer 131 during restoration is shown in the autotransformer output track of FIG. 15.

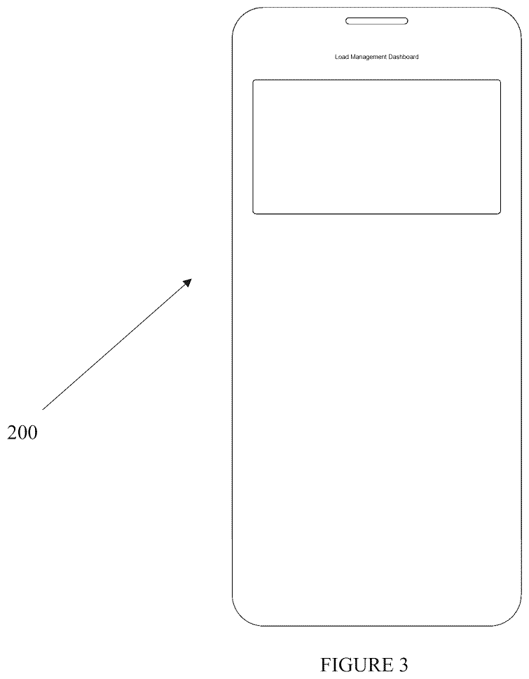

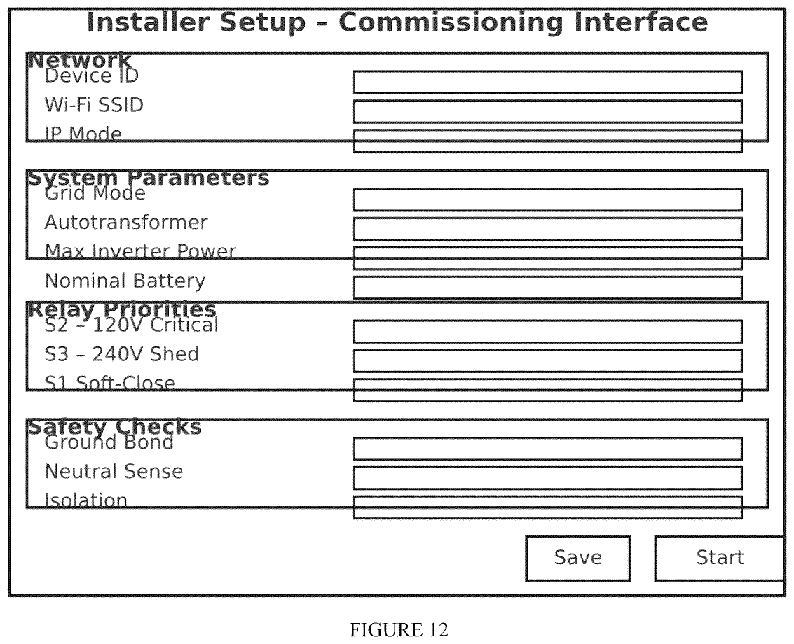

Mobile application 200, the graphical user interface thereof is shown in FIG. 3, may provide for monitoring, dynamic priorities, emergency override, and integration with voice assistants and geofencing. Installer workflows are shown in FIG. 12.

One embodiment of a method of operation of the present disclosure may start with power grid failure and detection thereof. Comparator-based neutral sensing circuit 120 detects power loss (shown in FIG. 15 in the 0-1 ms region), S1 111 opens around 5 milliseconds (ms) and S3 113 opens around 10 ms, while S2 112 remains closed in order to continue power to critical loads. Grid return triggers a validation interval and a 300-350 ms soft-close of S1 111. The 0-10 ms transient behavior is shown in the inset of FIG. 15.

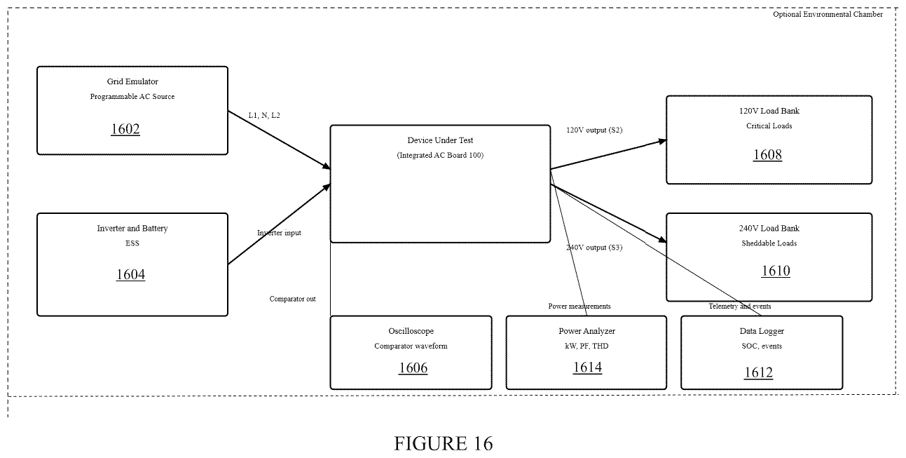

Testing of the system, both field and lab validation, used the configuration shown in FIG. 16 with a grid emulator, inverter/battery, load banks, and instrumentation. Comparator waveforms correspond to the oscilloscope channel indicated in FIG. 16.

FIG. 2 is an illustration showing one embodiment of a comparator-based neutral sensing circuit schematic. FIG. 2 shows reference divider R1/R2, RC filter R3/C1, hysteresis resistor R4, and comparator output to the processor. The comparator-based neutral sensing circuit 120 generates a grid status signal in sub-millisecond timeframes.

FIG. 3 is an illustration of one embodiment of a mobile application with a graphical user interface. The graphical user interface of the mobile app may present real-time power consumption (loads), battery prediction, status indicators, adjustable priorities, and an emergency override. The mobile application 200 preferably provides monitoring, dynamic priorities, emergency override, and integration with voice assistants and geofencing.

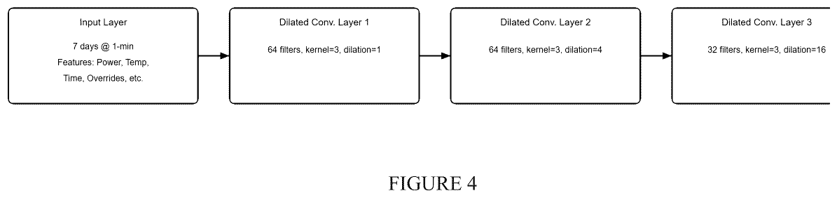

FIG. 4 is a flow diagram of one embodiment of a machine-learning algorithm architecture based on Temporal Convolutional Networks (TCN) with dilated convolutional layers and an output layer producing minute-resolution predictions.

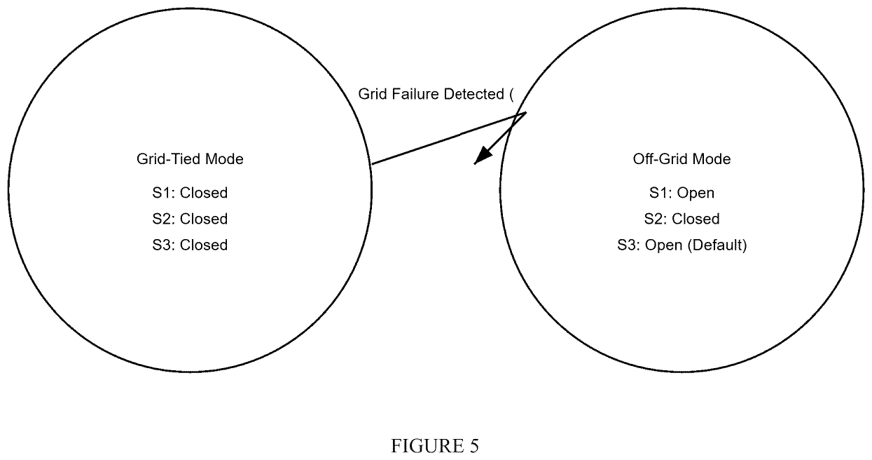

FIG. 5 is a state transition diagram of one embodiment for relay switching between grid-tied and off-grid modes with timing annotations. In grid-tied mode, all three switches 111, 112, 113, are closed. In off-grid mode (due to a detected power failure) S1 111 is open, S2 112 is closed, and S3 113 is open by default).

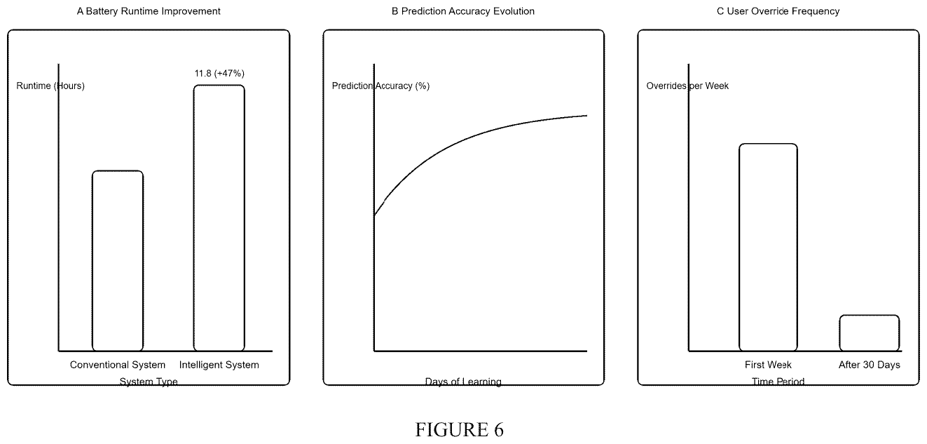

FIG. 6 is an illustration that presents comparative performance graphs including battery runtime improvement, prediction-accuracy evolution, and user-override frequency. As shown, the system of the present disclosure improves battery runtime performance and learns from user/system past behavior/choices, such that user override frequency is lowered as the system learns.

FIG. 7 is a data-flow diagram of one embodiment of the system showing sensor inputs, feature extraction, TCN training, prediction generation, and action selection. The processor executes a temporal convolutional network (TCN) trained on minute-resolution histories and contextual features. FIG. 7 shows an end-to-end data flow of the system, which may include sensor inputs 7002 (current, voltage, temperature), user interaction logs 7004, and external application programming interfaces 7006 (weather service, power company, utility pricing, etc.). The sensor inputs may be processed by a feature extraction engine 7008, which may provide temporal pattern recognition correlation analysis. This may be added to historical data store 7010 as part of a temporal convolution network 7012. This results in the system generating more and more accurate predictions 7014 of handling correctly power disruptions. Eventually, there is provided an optimized action selection 7016, which may generate relay control commands and update the mobile application user interface.

FIG. 8 is a block diagram that shows integration of external data sources with the predictive algorithm framework on the machine learning (ML) processor 8002, including weather 8004, time-of-use pricing 8006, and internal sensor data 8008, and the resulting optimized schedules and relay commands 8010. The ML processor 8002 may execute a temporal convolutional network (TCN) trained on minute-resolution histories and contextual features. As shown, input/output context and external-data integration (weather and time-of-use pricing) is provided.

FIG. 9 is an illustration of an exploded view of one embodiment of the hardware of the system enclosure. The mechanical stack and serviceability of one embodiment of the system are shown in this enclosure-level exploded view. FIG. 9 shows that the hardware for one embodiment of the system of the present disclosure may include the outer cover 9002, battery stack 9004, integrated AC board 9006 (which may be the same as AC board 100 shown in FIG. 1), and major subassemblies 9008.

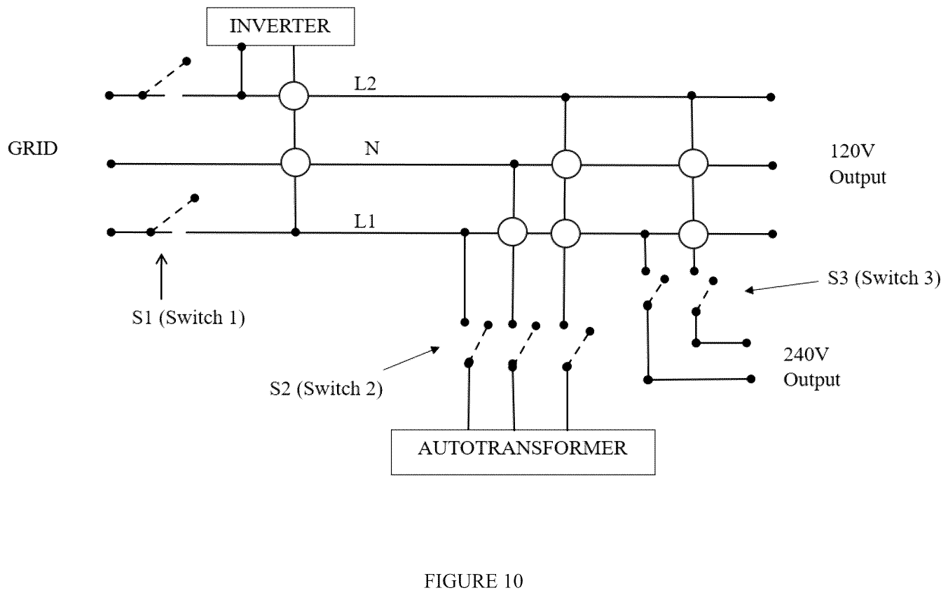

FIG. 10 is an illustration of one embodiment of wiring diagram of the system showing the relays that automatically shut off power to the 240V load/s when in off-grid mode. The input lines, as shown, grid and neutral (N) represent the connection to the main power supply. L1 and L2 represent the 120 v and 240 v inputs from the inverter, supplying power to both circuits on the AC board. Regarding the relay switches (S1, S2, S3), as shown: S1 serves as the primary connection point between input power and downstream circuits; S2 controls the 120V output circuit, remaining closed in off-grid mode to power essential loads; and S3 controls the 240V output circuit, which opens in off-grid mode by default to shed heavy loads but can be manually reactivated. The Autotransformer balances the 120V and 240V circuits, facilitating seamless switching and ensuring proper voltage regulation. Regarding the Output Circuits: (1) 120V Output 1 may be dedicated to essential 120V loads, active during off-grid mode; and (2) 240V Output 2 may be dedicated to 240V loads, automatically shed in off-grid mode but can be manually re-engaged. The system operation may comprise: (1) Grid Mode, wherein both 120V and 240V circuits are active; (2) Off-Grid Mode, wherein Relay S3 automatically opens, shedding 240V loads, Relay S2 remains closed, keeping essential 120V loads powered, and users can manually re-engage 240V circuits via the app. The system may include the following method steps for providing an intelligent load management: (1) Data Input-collects data on battery status, power consumption, user preferences, and weather/solar forecasts; (2) Machine Learning Engine-analyzes historical and real-time data to predict energy demand and optimize load shedding; (3) Forecast & Prioritization-based on predictions, assigns load priorities for 120V and 240V circuits; (4) Decision Point-determines whether to shed or re-engage specific circuits; (5) Relay Control-activates or deactivates relays based on load priorities; and (6) Feedback Loop-refines the machine learning model with performance data and user interactions. The intelligent load management system of the present disclosure offers a significant improvement over traditional methods by integrating real-time decision-making with predictive machine learning. It may provide homeowners with a flexible, energy-efficient way to manage off-grid power systems, balancing energy conservation with user control over load management. The mobile app interface may enhance user experience by allowing manual control while the system handles automatic, optimized energy distribution.

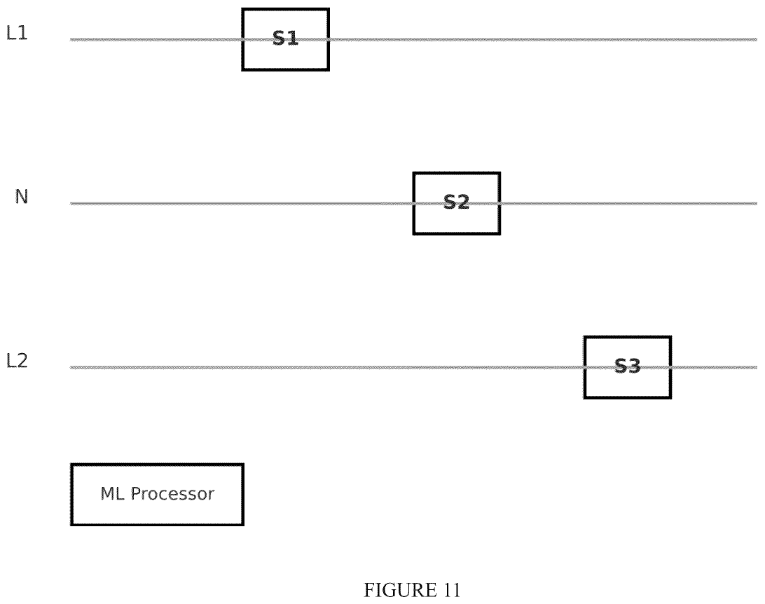

FIG. 11 is an illustration of one embodiment of a relay and breaker control schematic showing protection devices and control paths for S1-S3 and associated measurement points.

FIG. 12 is an illustration of one embodiment of an installer setup interface showing commissioning workflows and parameter provisioning. The interface may be on the hardware and/or the mobile application, such as mobile application 200. FIG. 12 shows the installer workflows that allow the user to view and change network, system parameters, relay priorities, and safety checks.

FIG. 13 is an illustration of an exploded view of one embodiment of an internal hardware of the system. FIG. 13 shows the hardware of the system of the present disclosure may have an inner arrangement that may include outer enclosure cover 900, cooling/fan unit 910, neuClick® battery modules 920, autotransformer 131, integrated AC board 100, and mounting backplate 930.

FIG. 14 is a flow block diagram of one embodiment of a wiring and harness map of the system. FIG. 14 shows internal busbars (electrical placement), harness connectors, the autotransformer 131 between S2 112 and S3 113, and external terminals for grid input (L1, N, L2), inverter input, and outputs.

FIG. 15A is a relay switching timing chart showing grid-loss detection, S1/S3 actuation, S2 hold, and soft-close of S1 upon grid return.

FIG. 15B is an inset zoom of FIG. 15A for 0-10 millisecond events.

FIGS. 15A and 15B show grid-loss detection, S1/S3 actuation, S2 hold, soft-close of S1 upon grid return, and an inset zoom for 0-10 millisecond events. Timing of open/close events relative to grid loss and restoration is depicted in FIG. 14 (5 ms open and 300-350 ms soft-close). FIGS. 15A and 15B show the temporal alignment of comparator events with relay actuation.

The autotransformer 131 is positioned between S2 and S3 (shown in FIG. 14) for voltage balancing and soft start; its effect during restoration is reflected in the autotransformer output track of FIG. 15B.

During grid failure detection and transition, the comparator detects loss, as shown in FIG. 15A (0-1 ms region), S1 opens around 5 ms and S3 opens around 10 ms, while S2 remains closed for critical loads. Grid return triggers a validation interval and a 300-350 ms soft-close of S1 as shown in FIG. 15B.

The 0-10 ms transient behavior is shown in FIG. 15A.

FIG. 16 is a block diagram of one embodiment of the system showing the experimental validation setup. FIG. 16 shows that the test included grid emulator 1602, inverter and battery 1604, the device under test, AC board 100, load banks 1608, 1610, and instrumentation, including oscilloscope 1606, power analyzer 1614, data logger 1612. The comparator waveforms correspond to the oscilloscope channel as shown in FIG. 16.

The systems and devices of the present disclosure have been presented in an illustrative style. The terminology employed throughout should be read in an exemplary rather than a limiting manner. While various exemplary embodiments have been shown and described, it should be apparent to one of ordinary skill in the art that there are many more embodiments that are within the scope of the devices and system of the present disclosure. Accordingly, the devices and systems of the present disclosure are not to be restricted, except in light of the appended claims and their equivalents.

Those of ordinary skill in the relevant art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

Various embodiments presented in terms of systems may comprise a number of components, modules, and the like. It is to be understood and appreciated that the various systems may include additional components, modules, etc. and/or may not include all of the components, modules, etc. discussed in connection with the figures. A combination of these approaches may also be used.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A load management system for battery energy storage systems comprising:
a comparator-based neutral sensing circuit that generates a grid status signal with a response time of less than one millisecond;
a machine learning processor that receives said grid status signal and executes a temporal convolutional network algorithm to generate a plurality of predictive load requirements; and
three relay switches, a first relay switch that controls a connection to a power grid, a second relay switch that controls a 120V circuit, and a third relay switch controls a 240V circuit;
wherein each of said three relay switches has an open position and a closed position;
wherein said machine learning processor predictively controls said three relay switches based on said plurality of predictive load requirements and said grid status signal, such that said third relay switch is automatically put into said open position during off-grid transitions while maintaining said second relay switch in said closed position.

2. The system of claim 1, wherein said comparator-based neutral sensing circuit comprises:
a voltage divider that generates a reference voltage;
a comparator that compares a neutral voltage to said reference voltage;
a filtering network that removes high-frequency noise; and
a feedback resistor that provides hysteresis.

3. The system of claim 1, wherein said temporal convolutional network algorithm comprises a plurality of multiple dilated convolutional layers with exponentially increasing dilation factors; and
wherein said temporal convolutional network algorithm processes historical usage data, temporal features, and sensor inputs to generate said plurality of predictive load requirements.

4. The system of claim 3, wherein said machine learning processor updates said temporal convolutional network based on a plurality of user override patterns to improve prediction accuracy.

5. The system of claim 1, further comprising:
a mobile application on a user device that is wirelessly connected and that has a graphical user interface that enables real-time user override of said relay switch positions.

6. The system of claim 5, wherein said graphical user interface displays predictive battery depletion curves based on said predictive load requirements.

7. The system of claim 1, further comprising:
an autotransformer positioned between said second and third relay switches that provides voltage balancing and soft-start capability.

8. The system of claim 1, wherein said comparator-based neutral sensing circuit, said machine learning processor, said three relay switches, are integrated into a single AC board.

9. The system of claim 1, wherein said machine learning processor generates predictions at least 24 hours in advance with confidence intervals.

10. The system of claim 1, wherein said comparator-based neutral sensing circuit provides a response that is at least ten times faster than a response from transformer-based sensing circuits.

11. A method for managing electrical loads in battery energy storage systems comprising:
monitoring grid status using a comparator-based neutral sensing circuit with sub-millisecond response time;
processing historical usage patterns through a temporal convolutional network to generate predictive load requirements;
detecting grid failures through said comparator-based neutral sensing circuit;
disconnecting, automatically, a 240V circuit while maintaining a 120V circuit based on said predictive load requirements;
updating said temporal convolutional network based on user override patterns.

12. The method of claim 11, further comprising:
pre-positioning one or more relay switches based on said predictive load requirements before anticipated load changes occur.

13. The method of claim 11, further comprising:
receiving a plurality of user override commands through a graphical user interface of a mobile application; and
incorporating said plurality of override commands as training data for said temporal convolutional network.

14. The method of claim 11, further comprising:
processing, by said temporal convolutional network, one or more features selected from the group of features consisting of: time of day; day of week;
historical consumption; temperature; and user override history.

15. An intelligent relay-based load management system with machine learning optimization and mobile application control for battery energy storage systems comprising:
an AC board; and
a user device that is in wireless communication with said AC board;
wherein said AC board comprises:
a comparator circuit that monitors a power system electrically connected to said AC board;
a microprocessor that executes machine learning algorithms;
three relay switches for load control; and
an autotransformer;
wherein said comparator circuit provides input data to said machine learning algorithms with a latency that is less than 100 microseconds, enabling said machine learning algorithms to detect patterns in grid behavior and predict load requirements with an accuracy of at least 85%;
wherein said three relay switches comprise a first relay switch that controls a connection to a power grid, a second relay switch that controls a 120V circuit, and a third relay switch controls a 240V circuit;
wherein each of said three relay switches has an open position and a closed position;
wherein said autotransformer is positioned between said second and third relay switches that provides voltage balancing and soft-start capability;
wherein said user device comprises an application that has a graphical user interface; and
wherein said graphical user interface enables real-time user override of said relay switch positions.

16. The system of claim 15, wherein said comparator is part of a comparator-based neutral sensing circuit that generates a grid status signal with a response time of less than one millisecond.

17. The system of claim 16, wherein said microprocessor receives said grid status signal and executes a temporal convolutional network algorithm to generate a plurality of predictive load requirements.

18. The system of claim 17, wherein said machine learning algorithms being executed on said microprocessor predictively control said three relay switches based on said plurality of predictive load requirements and said grid status signal, such that said third relay switch is automatically put into said open position during off-grid transitions while maintaining said second relay switch in said closed position.

19. The system of claim 18, wherein said temporal convolutional network algorithm comprises a plurality of multiple dilated convolutional layers with exponentially increasing dilation factors; and
wherein said temporal convolutional network algorithm processes historical usage data, temporal features, and sensor inputs to generate said plurality of predictive load requirements.

20. The system of claim 19, wherein said microprocessor updates said temporal convolutional network based on a plurality of user override patterns to improve prediction accuracy; and
wherein said graphical user interface displays predictive battery depletion curves based on said predictive load requirements.
